(19) United States
(12) Patent Application Publication
(10) Pub. No.: US 2010/0136240 A1
(43) Pub. Date: Jun. 3, 2010

(54) Process for Forming an Outward Grown Aluminide Coating

(76) Inventors: Matthew James O'Connell, Simpsonville, SC (US); Todd Steven Moran, Simpsonville, SC (US); Dennis William Cavanaugh, Simpsonville, SC (US)

Correspondence Address: CANTOR COLBURN, LLP, 20 Church Street, 22nd Floor, Hartford, CT, 06103, US

(21) Appl. No.: 11/745,116

(22) Filed: May 7, 2007

(51) Int. Cl. B05D 3/02; C22F 1/04; B05D 3/00

(52) U.S. Cl. 427/383.7; 148/535

(57) ABSTRACT

In one embodiment, a method for forming an aluminide coated article comprises: applying an aluminum composition to the article to form a precursor coating, heating the article to a migration temperature sufficient to diffuse a metal from the article into the precursor coating, and gasifying aluminum in the aluminum composition at a gasification temperature that is greater than or equal to the migration temperature. An outward grown aluminide coating forms on the article. In another embodiment, a method for forming an aluminide coated article, comprises: applying an aluminide composition an article to form a precursor coating, heating the article to a migration temperature of greater than or equal to 1,065° C., gasifying the aluminum at a gasification temperature of greater than or equal to 1,065° C., and forming an outward grown aluminide coating on less than 100% of a surface of the article.

### BACKGROUND

These turbine engine parts and components can include turbine airfoils such as blades and vanes, turbine shrouds, turbine nozzles, combustor components such as liners and deflectors, augmentor hardware of gas turbine engines and the like. The operating conditions within a gas turbine engine are both thermally and chemically hostile. Significant advances in high temperature capabilities have been achieved through the development of iron, nickel and cobalt-based superalloys and the use of environmental coatings capable of protecting superalloys from oxidation, hot corrosion, etc., but coating systems continue to be developed to improve the performance of the materials.

In the compressor portion of an aircraft gas turbine engine, atmospheric air is compressed to 10 to 25 times atmospheric pressure, and adiabatically heated to 800° F. to 1,250° F. in the process. This heated and compressed air is directed into a combustor, where it is mixed with fuel. The fuel is ignited, and the combustion process heats the gases to very high temperatures, up to approximately 3,000° F. (1,650° C.). These hot gases pass through the turbine, where airfoils fixed to rotating turbine disks extract energy to drive the fan and compressor of the engine, and the exhaust system, where the gases supply thrust to propel the aircraft. To improve the efficiency of operation of the aircraft engine, combustion temperatures have been raised. Of course, as the combustion temperature is raised, steps must be taken to prevent thermal degradation of the materials forming the flow path for these hot gases of combustion.

Components formed from iron, nickel and cobalt-based superalloys cannot withstand long service exposures if located in certain sections of a gas turbine engine. A common solution is to provide such components with an environmental coating that inhibits oxidation and hot corrosion. Coating materials that have found wide use for this superalloy generally include diffusion aluminide coatings.

Aluminide coatings are primarily used as barriers to oxidation as external layers on hot section turbine components. Slurry methods for applying this coating to date are inward diffusing nickel aluminide coatings, which tend to be brittle and not ideal to act as bond coatings for further thermal barrier coating application. High Al, primarily beta phase nickel aluminum (β-NiAl) based coatings, which contain additions of chromium (Cr) and reactive elements such as zirconium (Zr), hafnium (Hf), and yttrium (Y), have been developed to serve as bond coatings for thermal barrier coatings for gas turbine engine components. Such high Al, primarily beta phase nickel aluminum (β-NiAl) based coatings are disclosed in U.S. Pat. No. 6,153,313, issued Nov. 28, 2000; U.S. Pat. No. 6,255,001 B1, issued Jul. 3, 2001; U.S. Pat. No. 6,291,084 B1, issued Sep. 18, 2001, which are commonly assigned to General Electric Company.

These coatings may be applied, for example, by chemical vapor deposition, pack, slurry, and other methods. The slurry methods for coating typically rely on high activity aluminum rich compositions, which are typically diffused into the component at temperatures of about 1,400° F. to about 1,600° F.). This method produces an inward diffusion of aluminum to eventually faun a NiAl beta phase coating. This coating can be very brittle and may continue to diffuse into the substrate in service, changing the parent material composition, which in-turn may affect the subsequent repair cycles. A micro of this type of aluminide coating is shown in FIG. 1. The brittle nature of this coating has the potential to initiate cracking which may propagate into the substrate of components in service.

Therefore, there is an opportunity for alternative aluminide coatings.

### SUMMARY OF THE INVENTION

Disclosed herein are methods for forming outward grown aluminide coatings on articles and articles made therefrom.

In one embodiment, a method for forming an aluminide coated article comprises: applying an aluminum composition to the article to form a precursor coating, heating the article to a migration temperature sufficient to diffuse a metal from the article into the precursor coating, and gasifying aluminum in the aluminum composition at a gasification temperature that is greater than or equal to the migration temperature. An outward grown aluminide coating forms on the article.

In another embodiment, a method for forming an aluminide coated article comprises: applying a slurry to the article to faun a precursor coating, heating the article to a migration temperature to diffuse a metal from the article out into the slurry coating, gasifying the aluminum at a gasification temperature of greater than or equal to the migration temperature, and forming an outward grown aluminide coating. The slurry comprises an aluminum alloy, an activator, and a binder.

In yet another embodiment, a method for forming an aluminide coated article, comprises: applying an aluminide composition an article to form a precursor coating, heating the article to a migration temperature of greater than or equal to 1,065° C., gasifying the aluminum at a gasification temperature of greater than or equal to 1,065° C., and forming an outward grown aluminide coating on less than 100% of a surface of the article.

The above described and other features are exemplified by the following detailed description and appended claims.

### DETAILED DESCRIPTION

There is an opportunity for a low activity aluminum coating process, such that an outward grown coating is achieved. This outward grown coating would be particularly important for the repair of components not only in the recoating process, but in the stripping of the coating for the repair itself. This method may also prove to be an acceptable bond coat material as well.

The method of outwardly growing an aluminide coating produces a coated article that is ductile and may improve the life of the coating during engine service. A coated article comprising an outward grown coating has the repair advantage that the coating can be stripped without reducing the article wall thickness. Furthermore, the diffusion of aluminum into the article during service is reduced and limited to the stoichiometric equivalency of the aluminum and nickel at the coating interface. Hence, the parent material composition, and therefore the structural integrity of the article, is substantially retained. Also, the resultant coating can be up to 60% thinner than a typical diffusion coating while attaining similar or better thermal and mechanical performance.

The coating method comprises applying an aluminum composition, (e.g., slurry) comprising low activity aluminum (e.g., an aluminum alloy), with activator, and inert filler, to the article surface. The article is heated and a sufficient concentration of aluminum coating gas is produced, and held for a significant residence time, such that the formation of a desired outward grown coating is achieved. The concentration of coating gas residence time can be maintained by applying a second coating, e.g., a seal coating, over the slurry coating. This second coating can increase the residence time of the coating gas at the components surface and prevent it from dissipating during the heating process. The coated article is heated to a sufficient temperature (e.g., greater than or equal to about 980° C. (about 1,800° F.)) to diffuse metal (e.g., nickel, cobalt, and/or iron) from the article, and combine that with the aluminum present in the coating gas to form the outward grown coating. For example, to facilitate the movement of nickel out of the article where it reacts with the aluminum to form nickel aluminide (e.g., beta-NiAl).

The article (e.g., substrate) can be any article that can withstand the processing conditions and which is desired to comprise an aluminide coating. The coating is particularly useful on components that will be exposed to high temperatures, e.g., gas turbine components, and particularly a component comprising a superalloy, (e.g., a nickel (Ni) and/or cobalt (Co) based alloy (e.g., superalloy)). Exemplary high temperature alloys are disclosed in various references, such as U.S. Pat. No. 5,399,313 to Ross et al., and U.S. Pat. No. 4,116,723 to Gell et al.

The source of aluminum alloy applied to the article comprises and aluminum alloy Al-M, where M can be (Cr, Co, as well as other metals that reduce the diffusion coefficient of Al with respect to the metal from the article), activator(s), and binder(s), and optionally inert filler material(s). The activator is a material that initiates the formation of aluminum coating gas from the aluminum alloy. Not to be bound by theory, even though it is inevitable that some initial coating gas may be formed at temperatures that are too low for outward diffusion to occur, because the aluminum is in an alloy form (e.g., has a reduced diffusion coefficient with respect to the metal in the alloy) and there is not an over abundance of free pure aluminum (e.g., having a purity of greater than or equal to 98 wt % aluminum based upon the total weight of aluminum) to begin diffusing, the majority of the aluminum coating gas forms at a high enough temperature such that a metal from the article (e.g., nickel) is actively diffusing outward. This produces an acceptable balance of inward and mostly outward diffused nickel aluminide coating. For example, for an article comprising nickel, at a temperature of 870° C., substantially pure aluminum (as most slurries contain), will diffuse into the article prior to the nickel diffusing out of the article. The inward diffused aluminum will react with the nickel to form a diffusion area within the article comprising nickel aluminide (e.g., referred to herein as a “diffusion aluminide portion”). With the aluminum alloy and activator of the aluminum composition used here, however, a coating gas forms at a temperature (e.g., greater than 1,900° F. (about 1,035° C.) that facilitates the majority of the coating formation to be outward from the article. Since nickel becomes mobile at a temperature of 1,037° C. (also referred to as the migration temperature), and due to the control of the mobility of the aluminum, the nickel moves into the precursor coating where it reacts and combines with the aluminum to form an outward grown coating. This coating has a lower aluminum content than a diffusion aluminide portion, and therefore is more ductile.

The aluminum composition can be applied to the article via any technique that attains the desired distribution and thickness. Possible application techniques include, spraying, painting, dipping, brushing, “salt and peppering”, and/or injecting onto the surface of the component, as well as others.

Salt and peppering the aluminum composition onto the surface comprises applying a binder to the article in an area to receive the aluminum composition. The aluminum composition is then applied, as a dry solid (e.g., in powder form), to the article, thereby forming a sort of slurry or paste on the article. The composition will adhere to the binder and not adhere to other areas of the article. This process can optionally be repeated to increase the amount of aluminum composition applied to the article. Alternatively, or in addition, the aluminum composition can be formed into a slurry and then applied to the article. For example, the aluminum composition can include the binder instead of being disposed onto a binder. Hence the composition (initially and once applied to the article (for the slurry applications), and once applied to the article (for the salt and pepper applications)), comprises the aluminum, a binder, an activator, and optionally an inert filler. If applied in the form of a slurry, the slurry has a viscosity appropriate for the desired application technique (e.g., dipping, roll coating, spraying, painting, and so forth).

The aluminum in the composition is in the form of an alloy (e.g., to reduce the activity of the aluminum). The aluminum can be alloyed with various metals (M) such as chromium (Cr), cobalt (Co), iron (Fe), and so forth, as well as combinations comprising at least one of the forgoing metals. The alloy Al-M, can have a concentration of about 20 wt % to about 70 wt % Al, or, more specifically, about 30 wt % to about 60 wt % Al, or, even more specifically, about 35 wt % to about 50 wt % Al. The alloy can also comprise about 20 wt % to about 70 wt % M, or, more specifically, about 40 wt % to about 70 wt % M, or, even more specifically, about 50 wt % to about 65 wt % M. For example, the alloy (aluminum chromium (Al—Cr)) can comprise about 40 wt % to about 50 wt % Al and about 50 wt % to about 60 wt % Cr. The alloy can be in the form of a powder having various sizes. For example, all of the powder can have a size (as measured along a major axis), of less than or equal to about 125 micrometers (μm), or, more specifically, about 30 μm to about 120 μm, or, even more specifically, about 40 μm to about 80 μm, and, even more specifically, about 40 μm to about 60 μm.

The aluminum composition can further comprise activator(s) that can facilitate the liberation of the aluminum, e.g., the separation of the aluminum from the alloy and allow and/or facilitate the gasification of the aluminum, at a temperature greater than or equal to the migration temperature. Possible activators include aluminum salts (e.g., aluminum halides such as aluminum chloride, aluminum fluoride, and so forth), ammonium salts (e.g., ammonium halides, such as ammonium chloride, ammonium fluoride, and so forth; e.g., micro-encapsulated ammonium chloride, and so forth), and so forth, as well as combinations comprising at least one of the foregoing.

The aluminum composition can also comprise binder(s). The binder can be any material capable of adhering the aluminum composition to the article. Desirably, the binder can further function as an activator such that the aluminum in the composition will gasify after the article attains the migration temperature such that the migrated metal can react with the gasified aluminum to form the outgrown aluminide coating. Some possible binders include braze gel (e.g., Braz-binder Gel commercially available from Vitta Corporation, Bethal, Conn.); silica (SiO₂), such as colloidal silica; glycerol, and so forth, as well as combinations comprising at least one of the foregoing, such as Krylon® spray and so forth.

The composition can comprise can be less than or equal to about 30 weight percent (wt %) aluminum alloy, or, specifically, about 0.5 wt % to about 30 wt % aluminum alloy, or, more specifically, about 1 wt % to about 20 wt % aluminum alloy, and yet more specifically, about 2 wt % to about 10 wt % aluminum alloy, based upon a total weight of the composition (including the aluminum alloy(s), activator(s), binder(s), and inert filler(s)). The composition can also comprise about 0.5 wt % to about 30 wt % activator(s), or, more specifically, about 0.5 wt % to about 15 wt % activator(s), and yet more specifically, about 1 wt % to about 10 wt % activator(s), based upon a total weight of the composition (including the aluminum alloy(s), activator(s), binder(s), and inert filler(s)). The composition further comprises less than or equal to about 90 wt % inert filler, or, specifically, about 2 wt % to about 80 wt % inert filler, and more specifically, about 5 wt % to about 30 wt % inert filler, based upon a total weight of the composition (including the aluminum alloy(s), activator(s), binder(s), and inert filler(s)). In addition to the aluminum alloy(s), activator(s), and optional inert filler(s), the composition also comprises binder, wherein the balance of the composition can be binder, or, specifically, about 10 wt % to about 97 wt % binder, or, yet more specifically, about 30 wt % to about 80 wt % binder, or, yet more specifically, about 40 wt % to about 70 wt % binder, based upon a total weight of the composition (including the aluminum alloy(s), activator(s), binder(s), and inert filler(s)).

Desirably, to inhibit the inward migration of aluminum and/or to reduce the overall activity of aluminum in the composition, the composition comprises less than or equal to about 10 wt % free aluminum (wherein free aluminum is non-alloyed and is not oxidized), or, specifically, less than or equal to about 5 wt % free aluminum, or, more specifically, less than or equal to about 2 wt % free aluminum, or, yet more specifically, less than or equal to about 0.5 wt % free aluminum, and yet more specifically, no added free aluminum metal (besides as an impurity in the alloy), based upon a total weight of the composition (including the aluminum alloy(s), activator(s), binder(s), and inert filler(s)).

In order to attain the desired outward coating, the residence time of aluminum gas over the surface of the article, can be maintained at a desired level while the article is heated. In one embodiment, the residence time of aluminum can be controlled by applying a second coating, e.g., a sealing shell, over the slurry coat. The second coating can be applied to the slurry coat in a manner similar to those used to apply the slurry coat. The sealing shell can comprise a material capable of inhibiting the dissipation of the aluminum coating gas away from the article surface for a sufficient period of time to attain a desired coating thickness and/or aluminide composition. Exemplary coatings include aluminua (e.g., aluminum oxide grit, such as in a slurry form), and/or a zirconium oxide (e.g., a zirconia mono-shell similar to that for casting superalloys), as well as others, and combinations comprising at least one of the foregoing.

Alternatively, or in addition to the sealing shell, a mechanical inhibitor can be disposed near the coating to inhibit gas dissipation and/or the coating can be applied sufficiently thick to attain a desired residence time. The mechanical inhibitor can be a faun (e.g., mold), that substantially mimics the surface of the article, leaving a small or no gap between the aluminum composition coating and the mechanical inhibitor. With respect to the coating thickness, the thickness is dependent on the aluminum composition, whether a sealing shell and/or mechanical inhibitor are employed, and the type of sealing shell and/or mechanical inhibitor.

Depending on the amount of volatiles in the aluminum composition coating, and depending upon the porosity of the shell coating or mechanical inhibitor, the aluminum composition coating can be de-volatilized prior to the application of the sealing shell or use of the mechanical inhibitor. Devolatilization can be accomplished by heating the coated article to a sufficient temperature to remove the volatiles from the coating. For example, the coated article can be heated to a temperature of about 250° C. to about 320° C. to remove volatiles, e.g., for a period of about 0.5 hours (hr) to about 1 hr.

Once the aluminum residence time at the article can be enhanced, and the volatiles have optionally been removed, the article can be heated to a sufficient temperature and for a sufficient time to cause metal in the article to diffuse into and/or react with the aluminum of the aluminum composition coating and to form the desired aluminide coating. Temperatures of greater than or equal to about 1,065° C. can be employed or, specifically, temperatures of about 1,065° C. to about 1,095° C. The article can be heated for greater than or equal to about 0.25 hr, or, more specifically, about 0.5 hr to about 12 hr. In order to attain an about 38 micrometer (μm) to an about 64 μm thick aluminide outward grown coating on an article, the article can be heated for about 2 hr to about 8 hr.

Once the outward grown coating has been formed, the article can be cooled (actively and/or passively), and the second coating can be removed. Removal can be accomplished with any technique that does not also remove the aluminide outward grown coating. Possible removal techniques include glass bead peening, grit blasting (e.g., light grit blasting with fine media), water jetting, and other removal techniques that do not damage the underlying coating, as well as combinations comprising at least one of the foregoing techniques. The resultant coating can have an aluminum concentration, based upon the total weight of the outward grown coating, of less than or equal to 30 wt %, or, more specifically, about 18 wt % to about 30 wt %, or, even more specifically, about 16 wt % to about 25 wt %. Since diffusion aluminide coatings generally have an aluminum concentration as high as 38 wt % or so, the present outward grown coating can have a greater ductility than the diffusion coating, better low cycle fatigue performance, improved stability while maintaining wall thickness, as well as potentially better performance in the engine. The thickness of the outward grown coating can be up to and even exceeding about 255 μm, depending upon residence time, aluminum coating composition, and total time at temperature. In some embodiments, the outward grown coating thickness can be about 10 μm to about 130 μm, or, specifically, about 25 μm to about 120 μm, or, more specifically, about 50 μm to about 105 μm.

It has been discovered that the outward grown coatings described herein are more stable and ductile compared to inward diffusion aluminides (e.g., formed from a slurry comprising a high activity aluminum). For example, after 4,100 hours of engine operation, an outward grown nickel aluminide coating remains stable, with essentially no inward migration of the aluminum. With an inward diffusion aluminide, however, under the same conditions, the aluminum continues to migrate into the substrate, changing the composition of the base alloy, and possibly negatively affecting subsequent repair cycles.

During repair, parts are commonly exposed to high temperatures (e.g., 1,204° C. (2,200° F.)), for example, to close pores formed into the part. After 8 hours of exposure to such a temperature (1,204° C.), the outward grown aluminide coating was intact, with minimal to no depletion of the grain boundary. However, the diffusion aluminide coatings (e.g., formed with a slurry and high activity aluminum) can not withstand such temperatures (e.g., 1,204° C.) without melting out from the substrate material.

The present process enables the formation of an outward grown aluminide coating on a substrate. Advantages of these coatings are numerous, including improved stripping with less parent material loss (e.g., during rework and/or servicing of the article); reduced diffusion of aluminum into the base material, thereby limiting potentially detrimental composition changes; improved oxidation resistance; improved ductility; less cracking in handling and service (e.g., due to the ductility improvement; and/or greater resistance to continued diffusion and melting with high temperature heat treatments. A further advantage of the present coating and process is the controllability of the coating. The present coating can be applied to specific area(s) of the article, with the specific areas predetermine. In other words, the location of the final coating can be controlled without the use of masking and other techniques that can be time consuming and not fully successful. Hence, even without masking, the present coating can be formed on less than all (less than 100% of the article (e.g., the surface of the article)), or, specifically, less than or equal to about 90% of the surface of the article (e.g., about 65% to about 90%), or, more specifically, less than or equal to about 70% of the surface of the article, and can even be formed on about 5% to about 40% of the surface of the article. Furthermore, different coating thicknesses can be formed on different portions of the article, e.g., by applying a different aluminum coating composition and/or thickness to the portions prior to heating. The present process enables greater coating control in the production of an outward grown coating (e.g., as compared to vapor deposition or similar technique).

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for forming an aluminide coated article, comprising:
applying an aluminum composition to the article to form a precursor coating, wherein the aluminum composition comprises an aluminum alloy and an activator;
heating the article to a migration temperature sufficient to diffuse a metal from the article into the precursor coating; and
gasifying aluminum in the aluminum composition at a gasification temperature that is greater than or equal to the migration temperature; and
wherein an outward grown aluminide coating forms on the article.

2. The method of claim 1, further comprising enhancing a residence time of the gasified aluminum at the article.

3. The method of claim 2, wherein enhancing the residence time comprises applying a second coating over the precursor coating and/or disposing a mechanical inhibitor near the article.

4. The method of claim 3, wherein the second coating is selected from the group consisting of alumina, zirconia, and combinations comprising at least one of the foregoing.

5. The method of claim 3, further comprising removing the second coating from the coated article.

6. The method of claim 1, wherein the precursor coating comprises
about 0.5 wt % to about 30 wt % aluminum alloy;
about 0.5 wt % to about 30 wt % activator;
less than or equal to about 90 wt % inert filler; and
about 10 wt % to about 97 wt % binder;
wherein the weight percentages are based upon a total weight of the precursor coating.

7. The method of claim 6, wherein the precursor coating comprises
about 1 wt % to about 20 wt % aluminum alloy;
about 0.5 wt % to about 15 wt % activator;
about 5 wt % to about 30 wt % inert filler; and
about 30 wt % to about 80 wt % binder.

8. The method of claim 1, wherein the aluminum alloy comprises about 20 wt % to about 70 wt % aluminum and about 20 wt % to about 70 wt % M, wherein M is selected from the group consisting of chromium, cobalt, iron, and combinations comprising at least one of the foregoing.

9. The method of claim 8, wherein the aluminum alloy comprises, about 35 wt % to about 50 wt % Al and about 50 wt % to about 65 wt % M.

10. The method of claim 1, wherein the sufficient temperature is greater than or equal to about 1,065° C.

11. The method of claim 1, wherein the outward coating comprises less than or equal to 30 wt % aluminum, based upon a total weight of the outward grown coating.

12. The method of claim 11, wherein the outward coating comprises about 16 wt % to 25 wt % aluminum, based upon a total weight of the outward grown coating.

13. The method of claim 1, wherein applying the aluminum composition further comprises applying a binder to the article and attaching the aluminum composition to the binder.

14. The method of claim 1, wherein the activator comprises a material selected from the group consisting of aluminum salts, ammonium salts, and combinations comprising at least one of the foregoing.

15. The method of claim 1, wherein the outward grown aluminide coating is a NiAl coating.

16. A method for forming an aluminide coated article, comprising:
applying a slurry to the article to form a precursor coating, wherein the slurry comprises an aluminum alloy, an activator, and a binder;
heating the article to a migration temperature to diffuse a metal from the article out into the slurry coating;
gasifying the aluminum at a gasification temperature of greater than or equal to the migration temperature; and
forming an outward grown aluminide coating.

17. A method for forming an aluminide coated article, comprising:
applying an aluminide composition an article to form a precursor coating, wherein the aluminide composition comprises an aluminum alloy and an activator;
heating the article to a migration temperature of greater than or equal to 1,065° C.;
gasifying the aluminum at a gasification temperature of greater than or equal to 1,065° C.; and
forming an outward grown aluminide coating on less than 100% of a surface of the article.

18. The method of claim 17, wherein the aluminide coating comprises a thickness of about 25 μm to about 120 μm, and has an aluminum content of less than or equal to 25 wt %, based upon a total weight of the outward grown aluminide coating.

19. The method of claim 17, wherein the aluminide composition is applied to less than or equal to about 90% of the surface.

20. The method of claim 19, wherein the aluminide composition is applied to about 5% to about 40% of the surface.
